(19) United States
(12) Patent Application Publication
(10) Pub. No.: US 2026/0229939 A1
(43) Pub. Date: Aug. 6, 2026

(54) ELECTRIC MACHINE ROTOR INCLUDING HELICAL KEYWAY IN COOPERATION WITH LAMINATION CORE

(71) Applicant: GM Global Technology Operations LLC, Detroit, MI (US)

(72) Inventors: Rebecca K. RISKO CATTELL, Royal Oak, MI (US); Edward L. Kaiser, Orion, MI (US); Cheongun Han, Novi, MI (US); Matthew James Bozich, Warren, MI (US)

(21) Appl. No.: 19/046,169

(22) Filed: Feb. 5, 2025

(51) Int. Cl. H02K 1/2706

(52) U.S. Cl. CPC H02K 1/2706; H02K 2201/06; H02K 2213/03

(57) ABSTRACT

An electric machine including: a slot defined by a rotor hub, the slot skewed relative to an axis of rotation; a first stack of first lamination sheets mounted to the rotor hub each including first tabs seated in the slot, cooperation between the first tabs at opposite ends of the first stack and the slot restricts movement of the first stack relative to the rotor hub; a plurality of first magnets mounted to the first stack; a second stack of second lamination sheets mounted to the rotor hub each including second tabs seated in the slot, cooperation between the second tabs at opposite ends of the second stack and the slot restricts movement of the second stack relative to the rotor hub; and a plurality of second magnets mounted to the second stack. The plurality of first and second magnets are skewed relative to each other.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a rotor assembly for an electric machine.

An electric machine includes a stator and a rotor. The stator generally includes a stator core and stator windings. The rotor sits inside of the stator core and is rotatably mounted on bearings. A rotor core includes a plurality of laminated plates mounted to a hub or shaft of the rotor. In the case of a permanent magnet motor-generator, magnets are mounted to the laminated plates. The rotor interacts with the magnetic field produced by the stator to create motion in the case of a motor, or generate electricity in the case of a generator.

### SUMMARY

The present disclosure provides for, in various features, an electric machine including the following: a rotor hub configured to rotate within a stator about an axis of rotation; a slot defined by the rotor hub, the slot skewed relative to the axis of rotation; a first stack of first lamination sheets mounted to the rotor hub, the first lamination sheets each including first tabs seated in the slot, cooperation between the first tabs at opposite ends of the first stack and the slot restricts movement of the first stack relative to the rotor hub; a plurality of first magnets mounted to the first stack; a second stack of second lamination sheets mounted to the rotor hub, the second lamination sheets each including second tabs seated in the slot, cooperation between the second tabs at opposite ends of the second stack and the slot restricts movement of the second stack relative to the rotor hub; and a plurality of second magnets mounted to the second stack. The plurality of first magnets and the plurality of second magnets are skewed relative to each other.

In further features, the electric machine is a permanent magnet motor-generator.

In further features, the first stack and the second stack are identical, the electric machine further comprising a plurality of additional stacks of additional laminations mounted to the rotor hub that are identical to the first stack and the second stack, and each one of the first stack, the second stack, and the plurality of additional stacks are all rotationally offset from each other about the axis of rotation.

In further features, the slot extends at a skewed angle of 4°-5° relative to the axis of rotation.

In further features, the first stack and the second stack are identical, mounted to the rotor hub directly adjacent to each other, and rotationally offset about the axis of rotation by 1°.

In further features, the slot defines a pair of opposing flanges, seated below the pair of opposing flanges are the first tabs at opposite ends of the first stack and the second tabs at opposite ends of the second stack.

In further features, the first tabs are aligned parallel to the axis of rotation; the second tabs are aligned parallel to the axis of rotation; and the first tabs and the second tabs are rotationally offset from each other about the axis of rotation.

In further features, each one of the first tabs and each one of the second tabs has a width that is less than a distance between opposing flanges of the slot.

In further features, the first tabs are arranged in first groups of alternating widths, and the second tabs are arranged in second groups of alternating widths.

In further features, the first tabs at opposite ends of the first stack are relatively wider than the first tabs of adjacent first groups, and the second tabs at opposite ends of the second stack are relatively wider than the second tabs of adjacent second groups.

In further features, the first groups include at least four of the first lamination sheets, and the second groups include at least four of the second lamination sheets.

The present disclosure further provides for, in various features, an electric machine including: a rotor hub configured to rotate within a stator about an axis of rotation; a slot defined by the rotor hub, the slot skewed relative to the axis of rotation; a first stack of first laminations mounted to the rotor hub, the first laminations each including first tabs aligned parallel to the axis of rotation and arranged in groups of alternating widths, cooperation between relatively wide ones of the first tabs at opposite ends of the first stack and the slot restricts movement of the first stack relative to the rotor hub; a plurality of first magnets mounted to the first stack; a second stack of second laminations mounted to the rotor hub, the second laminations each including second tabs aligned parallel to the axis of rotation and arranged in groups of alternating widths, cooperation between relatively wide ones of the second tabs at opposite ends of the second stack and the slot restricts movement of the second stack relative to the rotor hub; and a plurality of second magnets mounted to the second stack. The first stack is identical to the second stack, and the first stack is rotated relative to the second stack such that the first tabs and the second tabs are rotationally offset from each other about the axis of rotation.

In further features, the electric machine further comprising a plurality of additional stacks mounted to the rotor hub that are identical to the first stack and the second stack, each one of the first stack, the second stack, and the plurality of additional stacks are all rotationally offset from each other about the axis of rotation.

In further features, the slot extends at a skewed angle of 4°-5° relative to the axis of rotation; and the first stack and the second stack are directly adjacent to each other and rotationally offset about the axis of rotation by 1°.

In further features, the electric machine is a permanent magnet motor-generator.

The present disclosure also provides for, in various features, an electric machine including: a stator including stator coils; a rotor hub within the stator and configured to rotate about an axis of rotation; a slot defined by the rotor hub, the slot skewed relative to the axis of rotation; a first stack of first laminations mounted to the rotor hub, the first laminations each including first tabs arranged in groups of alternating widths, cooperation between relatively wide ones of the first tabs at opposite ends of the first stack and the slot restricts movement of the first stack relative to the rotor hub; a plurality of first magnets mounted to the first stack; a second stack of second laminations mounted to the rotor hub, the second laminations each including second tabs arranged in groups of alternating widths, cooperation between relatively wide ones of the second tabs at opposite ends of the second stack and the slot restricts movement of the second stack relative to the rotor hub; and a plurality of second magnets mounted to the second stack. The first tabs and the second tabs are rotationally offset from each other about the axis of rotation.

In further features, the first stack is identical to the second stack, and the first stack is rotated relative to the second stack.

In further features, the first tabs are aligned parallel to the axis of rotation and the second tabs are aligned parallel to the axis of rotation.

In further features, the slot extends at a skewed angle of 4°-5° relative to the axis of rotation; and the first stack and the second stack are directly adjacent to each other and rotationally offset about the axis of rotation by 1°.

In further features, each one of the first tabs and each one of the second tabs have a width that is less than a distance between opposing flanges of the slot.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an electric machine including a stator and a rotor assembly in accordance with the present disclosure;

FIG. 2 is a side view of the rotor assembly of FIG. 1;

FIG. 3 is another side view of the rotor assembly with numerous laminations removed to expose a rotor hub and a slot to which the laminations are mounted to;

FIG. 4 is a side view of the channel with tabs of the laminations seated therein to mount the laminations to the hub;

FIG. 5 is a perspective view of a stack of the laminations, each lamination including a tab configured to sit within the slot; and

FIG. 6 is a cross-sectional view of the slot with the tabs of the laminations seated therein.

In the drawings, reference numbers may be reused to identify similar and/or identical elements.

### DETAILED DESCRIPTION

The present disclosure is directed to an electric machine, which may be configured as a motor or a generator. For example, the electric machine may be a permanent magnet motor-generator configured for automotive or non-automotive use. The electric machine generally includes a rotor hub configured to rotate about an axis of rotation within a stator. The rotor hub defines a slot, which is skewed relative to the axis of rotation. Seated on the rotor hub are a plurality of laminations grouped in stacks. Each lamination of each stack includes a tab at an interior of the lamination. Each tab is sized and shaped to be received within the slot. The tabs are arranged in alternating groups of relatively wide tabs and relatively narrow tabs. The relatively wide tabs are at opposite ends of each stack.

Cooperation between the relatively wide tabs at the opposite ends of each stack and the slot locks the stacks to the hub, which prevents rotation of the stacks relative to the hub. Relatively narrow tabs that are inward of the wider tabs at opposite ends of the stacks do not contact sidewalls or outer flanges of the slot, which reduces stress on the laminations. Arranging the relatively narrow tabs adjacent to the relatively wide tabs in an alternating configuration allows the relatively wide tabs to flex while the laminations are pressed onto the hub during assembly, which further reduces stress on the relatively wide tabs and the laminations generally. Because the slot is skewed, the tabs of the different stacks are rotationally offset from each other about the axis of rotation. Magnets mounted to the stacks are also rotationally offset from each other about the axis of rotation, which reduces any occurrences of noise, vibration, and harness.

The tabs of each stack of laminations are aligned parallel to the axis of rotation. But the slot that the tabs are seated in is skewed relative to the axis of rotation. As a result, only corners of the relative wide tabs at opposite ends of each stack contact sidewalls and/or outer flanges of the slot. And, the corners of the tabs in contact with the slot are opposing corners (i.e., left corners of tabs at one end of the stack contact a left side of the slot, and right corners of tabs at an opposing end of the stack contact a right side of the slot). Configuring the tabs such that only corners of relatively wide tabs at opposing ends of the stacks contact the slot to lock the stacks of laminations to the hub accommodates any manufacturing variations that may be present amongst various hubs and laminations, thereby facilitating manufacturing and assembly.

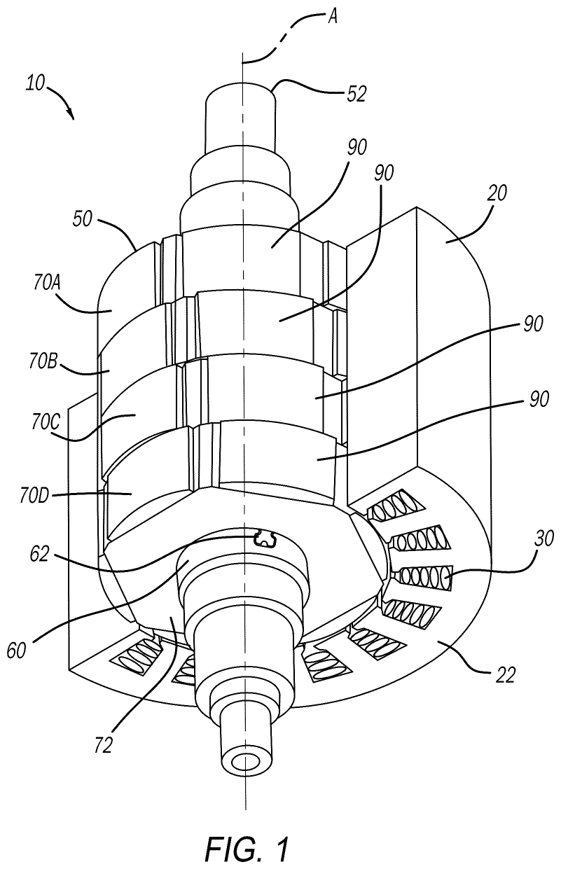

FIG. 1 illustrates an example of an electric machine 10 in accordance with the present disclosure. The electric machine 10 may be any suitable motor-generator, such as a permanent magnet motor-generator. The electric machine 10 may be configured for any suitable automotive use, as well as any suitable non-automotive use.

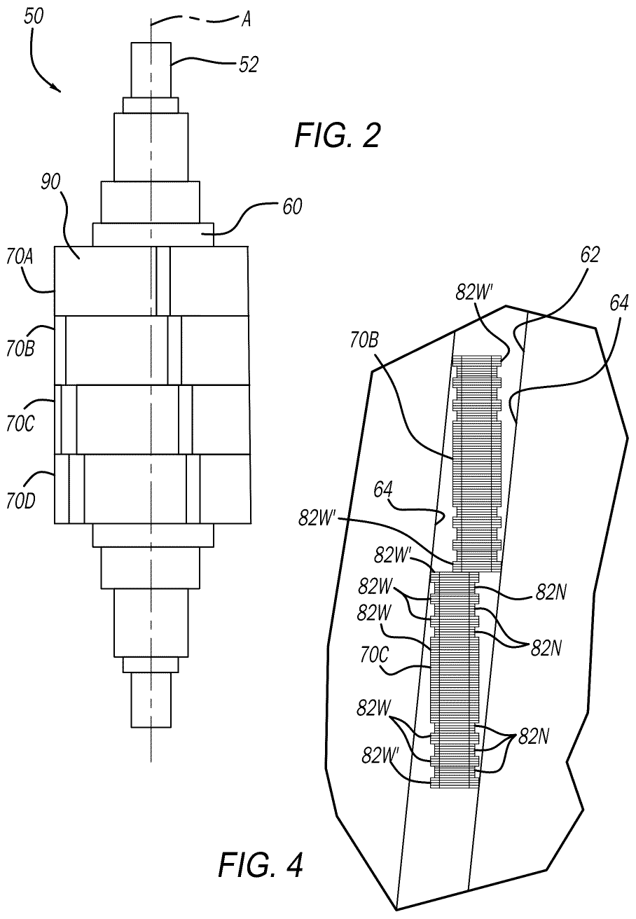

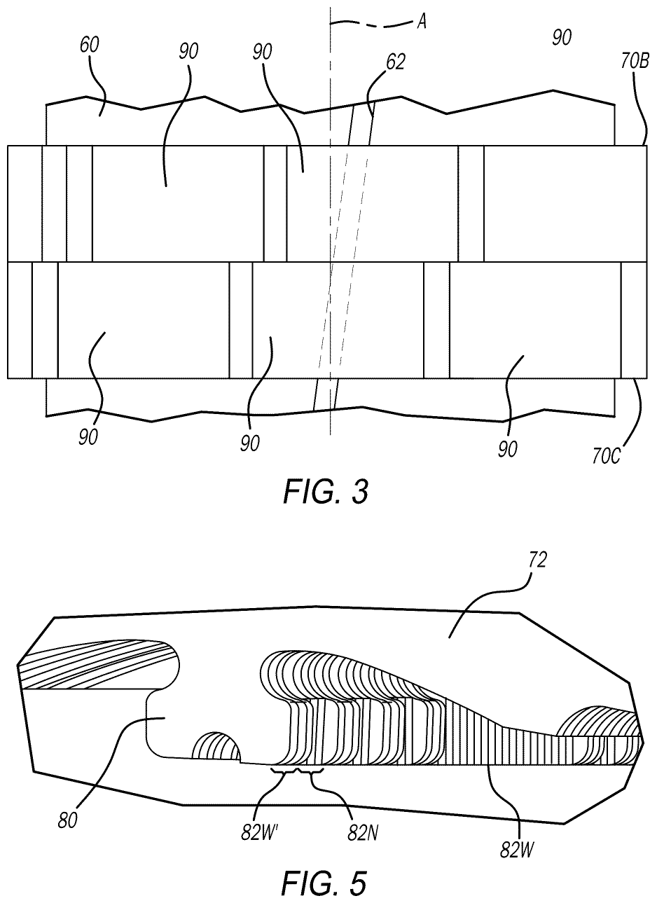

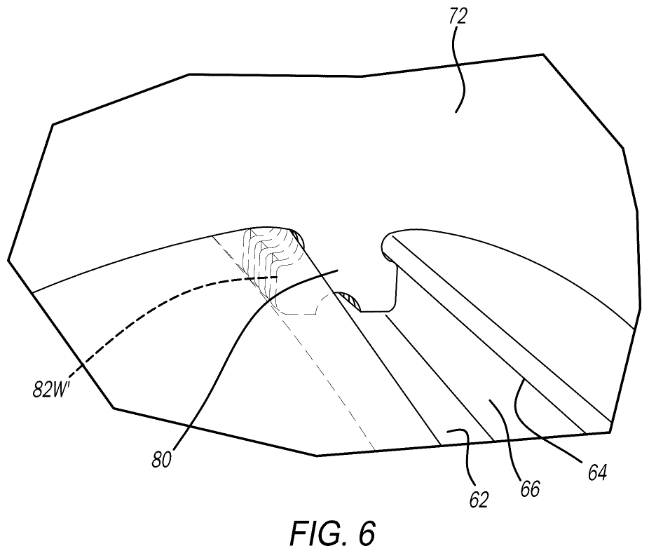

The electric machine 10 generally includes a stator 20 and a rotor 50. The stator 20 includes a plurality of stator laminations 22 and stator coils 30. The stator 20 surrounds the rotor 50. The rotor 50 is rotatable within the stator 20 about an axis of rotation A, as illustrated in FIGS. 1-3, for example. The rotor 50 includes a shaft 52 and a hub 60 mounted to the shaft 52 and rotatable with the shaft 52. The hub 60 defines a slot 62, which is skewed relative to the axis of rotation A, as particularly illustrated in FIG. 3. With referenced to FIG. 6, for example, the slot 62 includes a pair of opposing flanges 64 and sidewalls 66. In some applications, the slot 62 may be defined directly in the shaft 52.

The rotor 50 further includes a plurality of lamination stacks mounted to the hub 60. Any suitable number of lamination stacks may be included. In the example illustrated, the electric machine 10 includes a first lamination stack 70A, a second lamination stack 70B, a third lamination stack 70C, and a fourth lamination stack 70D. Each one of the lamination stacks 70A-70D includes a plurality of laminations 72 stacked together. The laminations 72 are each thin sheets of metal bound together in any suitable manner and made of any suitable material, such as silicon steel. The laminations 72 may have any suitable thickness, such as a thickness of 0.25 mm per sheet. Each one of the lamination stacks 70A-70D are the same, or substantially similar to each other.

With reference to FIGS. 4-6, for example, each one of the laminations 72 includes a tab 80, which extends inward towards an axial center of each one of the laminations 72 and towards the axis of rotation A. The tabs 80 sit within the slot 62 to lock the lamination stacks 70A-70D relative to the hub 60 and prevent rotation of the lamination stacks 70A-70D relative to the hub 60, thereby preventing backlash, as explained further below. Each one of the lamination stacks 70A-70D further includes magnets 90, which in the example illustrated are spaced apart about an exterior of each one of the lamination stacks 70A-70D.

The tabs 80 of each one of the lamination stacks 70A-70D are arranged in alternating groups of wide tabs 82W and narrow tabs 82N. The wide tabs 82W are relatively wider than the narrow tabs 82N. The narrow tabs 82N may be, for example, machined down to a more narrow size relative to the wide tabs 82W. The wide tabs 82W and the narrow tabs 82N are arranged in an alternating fashion across each of the rotor lamination stacks 70A-70D (see FIGS. 4 and 5, for example). Each group of the wide tabs 82W and the narrow tabs 82N may include any suitable number of the tabs 80, such as four of the tabs 80 each having a thickness of 0.25 mm. Thus, each group of the wide tabs 82W and the narrow tabs 82N may be 1 mm thick, or about 1 mm thick, for example. The wide tabs 82W have a maximum width that is less than a distance between the opposing flanges 64 of the slot 62, thereby facilitation insertion of the tabs 80 into the slot.

The wide tabs 82W and the narrow tabs 82N are arranged such that a group of wide tabs 82W′ is at each end of the assembly of the wide tabs 82W and the narrow tabs 82N. Directly adjacent to the wide tabs 82W′ at the ends is a group of the narrow tabs 82N, which provides clearance for the wide tabs 82W′ to bend (or deflect) during insertion into the slot 62. The tabs 80 are configured such that when seated in the slot 62, only the wide tabs 82W′ at the opposite ends of each one of the rotor lamination stacks 70A-70D make contact with the sidewalls 66 and/or the flanges 64 of the slots.

For example, and with reference to FIG. 4, a left side of the upper end group of the wide tabs 82W′ contacts a left side of the slot 62, while a right side of the upper end group of the wide tabs 82W′ does not contact the right side of the slot 62. A right side of the lower end group of the wide tabs 82W′ contacts a right side of the slot 62, while a left side of the lower end group of the wide tabs 82W′ does not contact the left side of the slot 62. As a result, relatively less stress is transferred to the laminations 72 than if both sides of the wide tabs 82W′ and all of the remaining tabs 80 were in contact with the sidewalls 66 and/or the flanges 64. Configuring the tabs 80 such that only corners of relatively wide tabs 82W′ at opposing ends of the stacks contact the slot 62 to lock the rotor lamination stacks 70A-70D to the hub 60 accommodates any manufacturing variations that may be present amongst various hubs 60 and the laminations 72, thereby facilitating manufacturing and assembly.

When seated within the slot 62, the tabs 80 of each one of the rotor lamination stacks 70A-70D are aligned parallel to the axis of rotation A, even though the slot 62 is skewed relative to the axis of rotation A, as illustrated in FIG. 4 for example. The slot 62 may be skewed at any suitable angle relative to the axis of rotation A, such as about 4.0°, and in particular 4.5°. Because the slot 62 is skewed and the tabs 80 are all parallel to the axis of rotation, the rotor lamination stacks 70A-70D are all rotationally offset from each other about the axis of rotation A. With the slot 62 skewed at 4.5° relative the axis of rotation A, adjacent ones of the rotor lamination stacks 70A-70D are rotationally offset by 1° or about 1°. As a result, the tabs 80 and the magnets 90 of adjacent ones of the rotor lamination stacks 70A-70D are rotationally offset by 1° or about 1°. Arranging the magnets 90 to be rotationally offset reduces any cogging torque and/or torque ripple that may occur during rotation of the rotor 50, which reduces any noise, vibration, or harshness that may be generated during operation of the electric machine 10.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is

1. An electric machine comprising:
a rotor hub configured to rotate within a stator about an axis of rotation;
a slot defined by the rotor hub, the slot skewed relative to the axis of rotation;
a first stack of first lamination sheets mounted to the rotor hub, the first lamination sheets each including first tabs seated in the slot, cooperation between the first tabs at opposite ends of the first stack and the slot restricts movement of the first stack relative to the rotor hub;
a plurality of first magnets mounted to the first stack;
a second stack of second lamination sheets mounted to the rotor hub, the second lamination sheets each including second tabs seated in the slot, cooperation between the second tabs at opposite ends of the second stack and the slot restricts movement of the second stack relative to the rotor hub; and
a plurality of second magnets mounted to the second stack,
wherein the plurality of first magnets and the plurality of second magnets are skewed relative to each other.

2. The electric machine of claim 1, wherein the electric machine is a permanent magnet motor-generator.

3. The electric machine of claim 1, wherein:
the first stack and the second stack are identical, the electric machine further comprising a plurality of additional stacks of additional laminations mounted to the rotor hub that are identical to the first stack and the second stack, and
each one of the first stack, the second stack, and the plurality of additional stacks are all rotationally offset from each other about the axis of rotation.

4. The electric machine of claim 1, wherein the slot extends at a skewed angle of 4°-5° relative to the axis of rotation.

5. The electric machine of claim 4, wherein the first stack and the second stack are identical, mounted to the rotor hub directly adjacent to each other, and rotationally offset about the axis of rotation by 1°.

6. The electric machine of claim 1, wherein the slot defines a pair of opposing flanges, seated below the pair of opposing flanges are the first tabs at opposite ends of the first stack and the second tabs at opposite ends of the second stack.

7. The electric machine of claim 1, wherein:
the first tabs are aligned parallel to the axis of rotation;
the second tabs are aligned parallel to the axis of rotation; and
the first tabs and the second tabs are rotationally offset from each other about the axis of rotation.

8. The electric machine of claim 1, wherein each one of the first tabs and each one of the second tabs has a width that is less than a distance between opposing flanges of the slot.

9. The electric machine of claim 1, wherein the first tabs are arranged in first groups of alternating widths, and the second tabs are arranged in second groups of alternating widths.

10. The electric machine of claim 9, wherein the first tabs at opposite ends of the first stack are relatively wider than the first tabs of adjacent first groups, and the second tabs at opposite ends of the second stack are relatively wider than the second tabs of adjacent second groups.

11. The electric machine of claim 9, wherein the first groups include at least four of the first lamination sheets, and the second groups include at least four of the second lamination sheets.

12. An electric machine comprising:
a rotor hub configured to rotate within a stator about an axis of rotation;
a slot defined by the rotor hub, the slot skewed relative to the axis of rotation;
a first stack of first laminations mounted to the rotor hub, the first laminations each including first tabs aligned parallel to the axis of rotation and arranged in groups of alternating widths, cooperation between relatively wide ones of the first tabs at opposite ends of the first stack and the slot restricts movement of the first stack relative to the rotor hub;
a plurality of first magnets mounted to the first stack;
a second stack of second laminations mounted to the rotor hub, the second laminations each including second tabs aligned parallel to the axis of rotation and arranged in groups of alternating widths, cooperation between relatively wide ones of the second tabs at opposite ends of the second stack and the slot restricts movement of the second stack relative to the rotor hub; and
a plurality of second magnets mounted to the second stack,
wherein the first stack is identical to the second stack, and the first stack is rotated relative to the second stack such that the first tabs and the second tabs are rotationally offset from each other about the axis of rotation.

13. The electric machine of claim 12, the electric machine further comprising a plurality of additional stacks mounted to the rotor hub that are identical to the first stack and the second stack,
wherein each one of the first stack, the second stack, and the plurality of additional stacks are all rotationally offset from each other about the axis of rotation.

14. The electric machine of claim 12, wherein:
the slot extends at a skewed angle of 4°-5° relative to the axis of rotation; and
the first stack and the second stack are directly adjacent to each other and rotationally offset about the axis of rotation by 1°.

15. The electric machine of claim 12, wherein the electric machine is a permanent magnet motor-generator.

16. An electric machine comprising:
a stator including stator coils;
a rotor hub within the stator and configured to rotate about an axis of rotation;
a slot defined by the rotor hub, the slot skewed relative to the axis of rotation;
a first stack of first laminations mounted to the rotor hub, the first laminations each including first tabs arranged in groups of alternating widths, cooperation between relatively wide ones of the first tabs at opposite ends of the first stack and the slot restricts movement of the first stack relative to the rotor hub;
a plurality of first magnets mounted to the first stack;
a second stack of second laminations mounted to the rotor hub, the second laminations each including second tabs arranged in groups of alternating widths, cooperation between relatively wide ones of the second tabs at opposite ends of the second stack and the slot restricts movement of the second stack relative to the rotor hub; and
a plurality of second magnets mounted to the second stack,
wherein the first tabs and the second tabs are rotationally offset from each other about the axis of rotation.

17. The electric machine of claim 16, wherein the first stack is identical to the second stack, and the first stack is rotated relative to the second stack.

18. The electric machine of claim 16, wherein the first tabs are aligned parallel to the axis of rotation and the second tabs are aligned parallel to the axis of rotation.

19. The electric machine of claim 16, wherein:
the slot extends at a skewed angle of 4°-5° relative to the axis of rotation; and
the first stack and the second stack are directly adjacent to each other and rotationally offset about the axis of rotation by 1°.

20. The electric machine of claim 16, wherein each one of the first tabs and each one of the second tabs have a width that is less than a distance between opposing flanges of the slot.
